(19) United States
(12) Patent Application Publication
(10) Pub. No.: US 2013/0046606 A1
(43) Pub. Date: Feb. 21, 2013

(54) LOYALTY POINT GIFT REGISTRY

(71) Applicants: Volodymyr MANDRYCHENKO, Oakville (CA); Simon Marc BRIGHTMAN, Toronto (CA); Michael Edward LOSSOS, Fenton, MO (US); Dena Raechelle KUZYK, Pincher Creek (CA); Andrew ISHERWOOD, Toronto (CA)

(72) Inventors: Volodymyr MANDRYCHENKO, Oakville (CA); Simon Marc BRIGHTMAN, Toronto (CA); Michael Edward LOSSOS, Fenton, MO (US); Dena Raechelle KUZYK, Pincher Creek (CA); Andrew ISHERWOOD, Toronto (CA)

(73) Assignee: POINTS.COM INC., Toronto (CA)

(21) Appl. No.: 13/587,757

(22) Filed: Aug. 16, 2012

Related U.S. Application Data
(60) Provisional application No. 61/523,976, filed on Aug. 16, 2011.

(51) Int. Cl. G06Q 30/02

(52) U.S. Cl. 705/14.27

(57) ABSTRACT

A loyalty point gift registry, and system and method for establishing and contributing to a loyalty point gift registry are provided. The method of establishing the loyalty point gift registry includes obtaining loyalty point account information for a loyalty point account. The loyalty point account has loyalty points. The loyalty point account information is linked to the loyalty point gift registry. A publicly accessible profile is generated for the loyalty point gift registry. The loyalty points are kept private and are not published in the publicly accessible profile. A third party can contribute at least one loyalty point to the loyalty point account using the publicly accessible profile.

### FIELD OF THE INVENTION

The present invention relates to a loyalty point gift registry.

### DESCRIPTION OF THE PRIOR ART

Loyalty programs are offered by merchants, associations and other organizations in order to reward, and thereby encourage, customer behaviour.

Recently, various systems have been provided for transferring loyalty points between loyalty point accounts associated with loyalty programs. Some of these systems require the contributor to provide loyalty account information of the receiver. Additionally, many such systems expose loyalty account information of the receiver to the contributor.

It is an object of the present invention to obviate or mitigate at least one of the above disadvantages.

### SUMMARY OF THE INVENTION

In one aspect, a method of establishing a loyalty point gift registry is provided, the method comprising: (a) obtaining loyalty point account information for a loyalty point account capable of accumulating loyalty points; (b) linking the loyalty point account information to the loyalty point gift registry; (c) generating, by one or more processors, a publicly accessible profile for the loyalty point gift registry that retains at least the loyalty points as private; and (d) enabling a contributor to contribute at least one loyalty point to the loyalty point account using the publicly accessible profile.

In another aspect, a system for establishing a loyalty point gift registry is provided, the system comprising a gift registry server operable to: (a) obtain loyalty point account information for a loyalty point account capable of accumulating loyalty points; (b) link the loyalty point account information to the loyalty point gift registry; (c) generate a publicly accessible profile for the loyalty point gift registry that retains at least the loyalty points as private; and (d) enable a contributor to contribute at least one loyalty point to the loyalty point account using the publicly accessible profile.

### BRIEF DESCRIPTION OF THE DRAWINGS

The features of the invention will become more apparent in the following detailed description in which reference is made to the appended drawings wherein:

FIG. 1 is a schematic representation of a system in accordance with the invention;

FIG. 2 is a flowchart illustrating an example of a method for establishing a gift registry;

FIG. 3 is a flowchart illustrating an example of a method for enabling a contributor to contribute to a gift registry;

FIG. 4 is a flowchart of an example of the gift registry system in use;

FIG. 5 is an example of a landing interface;

FIG. 6. is an example of a login/register interface;

FIG. 7 is an example of a gift registry setup interface;

FIG. 8 is an example of gift registry configuration interface;

FIG. 9 is an example of a setup confirmation interface;

FIG. 10 is an example of a main interface in the administrator portal;

FIG. 11 is an example of a sharing interface;

FIG. 12 is an example of a content upload interface;

FIG. 13 is an example of a configuration interface;.

FIG. 14 is an example of a credential configuration interface;

FIG. 15 is an example of a received gift interface;

FIG. 16 is an example of a preview interface;

FIG. 17 is an example of a feature landing interface;

FIG. 18 is an example of a purchase contribution interface;

FIG. 19 is an example of a payment interface;

FIG. 20 is an example of a payment confirmation interface;

FIG. 21 is an example of an emailed error notification;

FIG. 22 is an example of a receipt interface;

FIG. 23 is an example of an emailed receipt;

FIG. 24 is an example of an emailed gift notification;

FIG. 25 is an example of a sharing contribution interface;

FIG. 26 is an example of a payment interface;

FIG. 27 is an example of a sharing confirmation interface;

FIG. 28 is an example of an emailed error notification;

FIG. 29 is an example of a receipt interface;

FIG. 30 is an example of a sharing receipt; and

FIG. 31 is an example of an emailed error notification.

### DETAILED DESCRIPTION OF THE INVENTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It will also be appreciated that any unit, module, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

One aspect provides a system and method of establishing a loyalty point gift registry. Another aspect provides a system and method of enabling a contributor to provide a gift to a loyalty point gift registry owner.

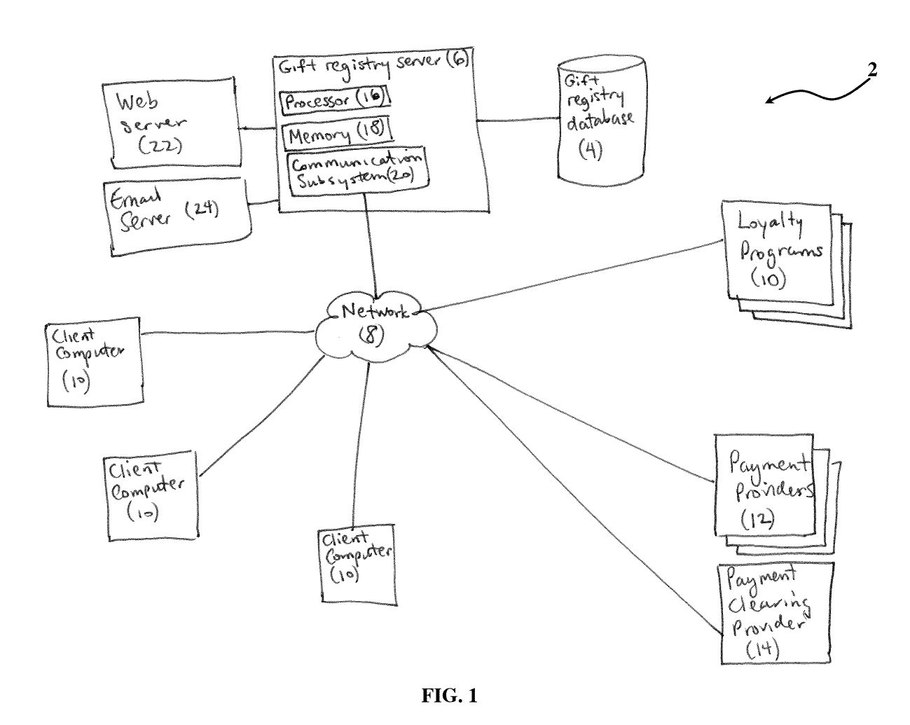

Referring now to FIG. 1, a system (2) comprises a gift registry database (4) communicatively linked to a gift registry server (6). The gift registry server comprises or is linked to a processor (16), a memory (18) and a communication subsystem (20). The communication subsystem (20) enables data to be communicated between the gift registry server (6) and other devices in the system. The gift registry database (4) is a storage medium operable to have recorded thereon electronic data representing the gift registries that are configured by the gift registry server (6).

The gift registry server (6) enables a user to establish a gift registry, thereby rendering the user an owner, and enables the user or other users to make contributions to gift registries, thereby rendering those users as contributors. Gift registries and contributions to gift registries are recorded on the gift registry database (4) by the gift registry server (6).

The gift registry server (6) is linked to a network (8), such as the Internet. The gift registry server (6) is further linked, preferably via the network (8), to at least one loyalty program (10) to enable the gift registry server (6) to interface with the at least one loyalty program (10). A particular gift registry configured by the gift registry server (6) is linked to an existing loyalty account, capable of accumulating loyalty points, associated with a loyalty program (10), as directed by the owner of the particular gift registry. The existing loyalty account is typically owned by the gift registry owner, although it is possible that the gift registry owner could be an agent for the loyalty account owner.

The gift registry server (6) may further be linked, preferably via the network (8), to at least one payment provider (12) or payment clearing provider (14) to enable payments from users to be processed for the gift registry server (6).

The gift registry server (6) is linked via the network (8) to one or more client computers (26). The gift registry server (6) preferably comprises or is linked to a web server (22) enabling the gift registry server (6) to serve web pages to the client computers (26) to provide a user interface for users of the client computers (26) to interact with the gift registry server (6). Users may interact with the gift registry server (6) to establish a gift registry, thereby enabling the user to be a gift registry owner, or make contributions to gift registries.

The gift registry server (6) may further comprise or be linked to an email server (24) for providing email notifications described herein.

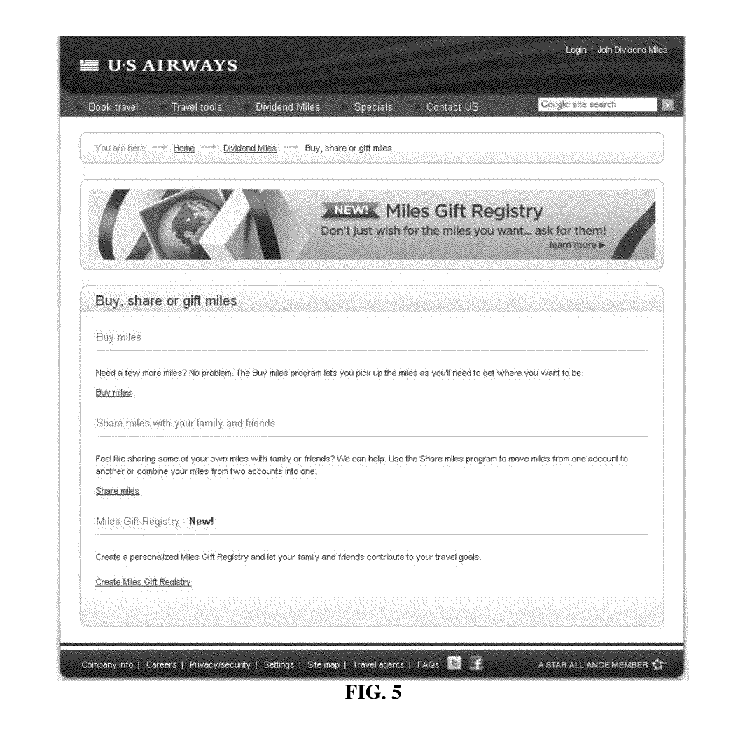

The gift registry server (6), preferably via the web server (22), provides a landing interface as exemplified in FIG. 5, to a user accessing the gift registry server (6). The landing interface enables the user to create a gift registry, whereby the gift registry server establishes the gift registry, or to contribute to a gift registry. In the present example, the user may select via the landing interface the option to create a gift registry.

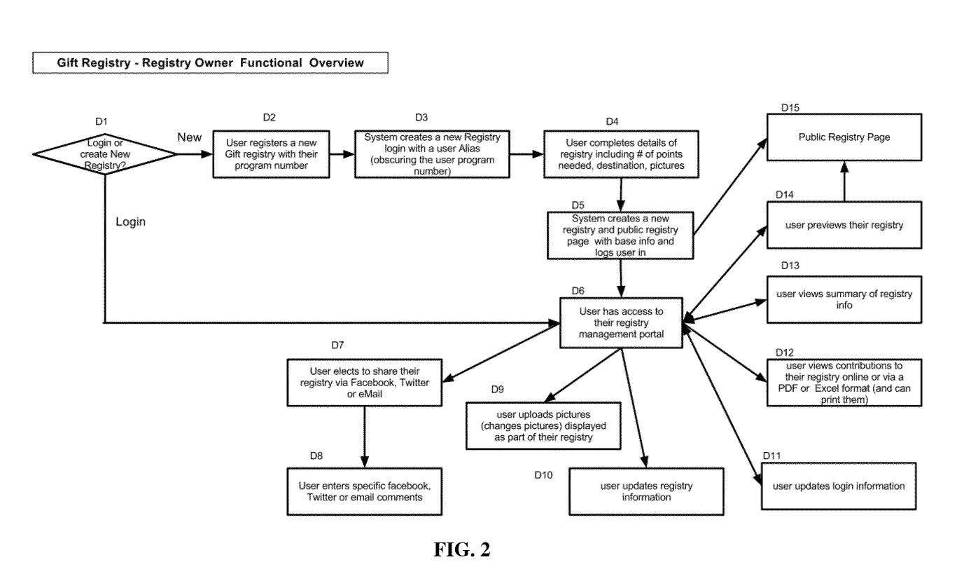

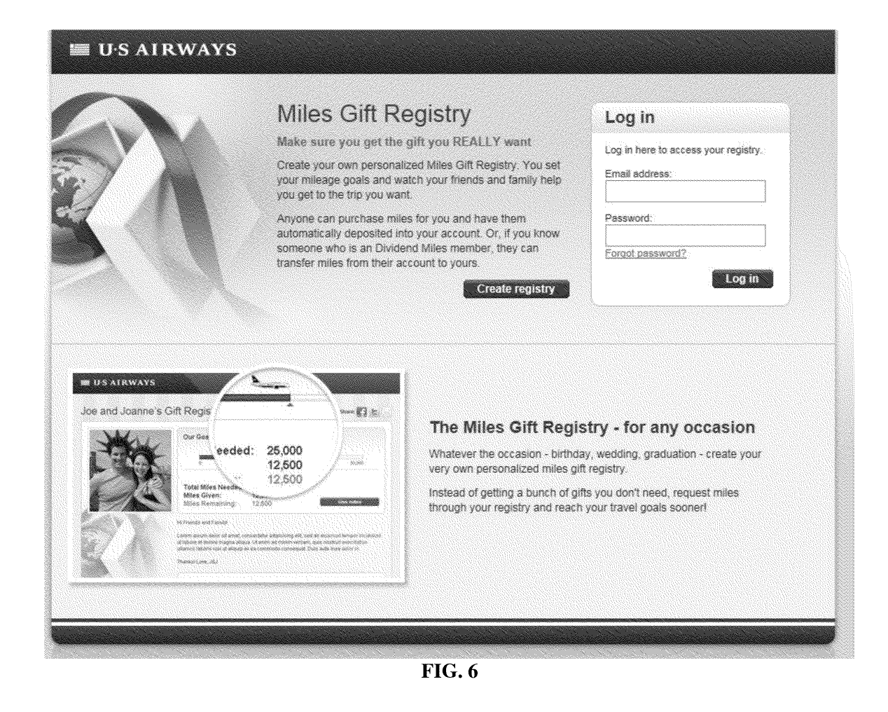

Upon selecting to create a gift registry, the process is shown in FIG. 2 proceeds to block D1, and the user is directed by the gift registry server to a login/register interface to enable the user to either register to establish a new gift registry or login to a previously established gift registry. An example of a login/register interface is shown in FIG. 6. Initially, the user may select to create a new gift registry and clicks a “create” or “register” command (shown as “create registry” in FIG. 6).

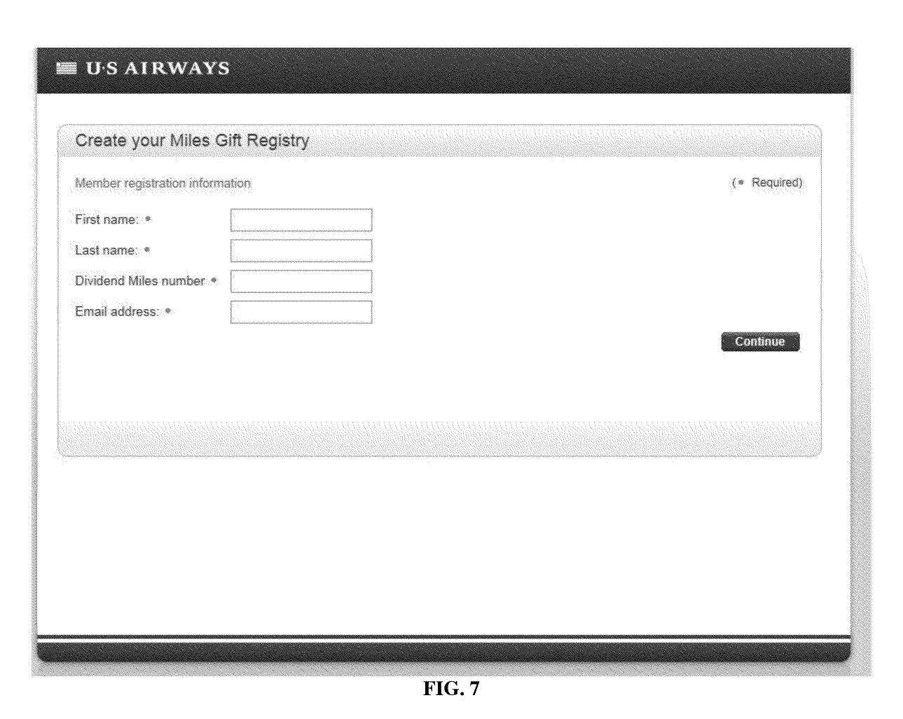

At block D2, the user is directed by the gift registry server to a gift registry setup interface, an example of which is shown in FIG. 7. The user may enter identification information (e.g., name), correspondence information (e.g., email address) and loyalty account information for the particular loyalty account for which the user wishes to create a gift registry. The gift registry server communicates with the respective loyalty program (10) to validate the loyalty account information.

Upon validating the loyalty account information, at block D3, the gift registry server creates a gift registry for the user and associated the gift registry with the specified loyalty account. The gift registry includes a unique user ID for the user, which can be generated so as to prevent potential contributors from determining the loyalty account information, such as credentials and account number, of the owner. The gift registry server may further provide the user with credentials, including a password or enabling the user to choose a password, to login to access the gift registry. At this time, the gift registry server may save the gift registry to the gift registry database. The user's ID and credentials can later be used to login to the gift registry at block Dl.

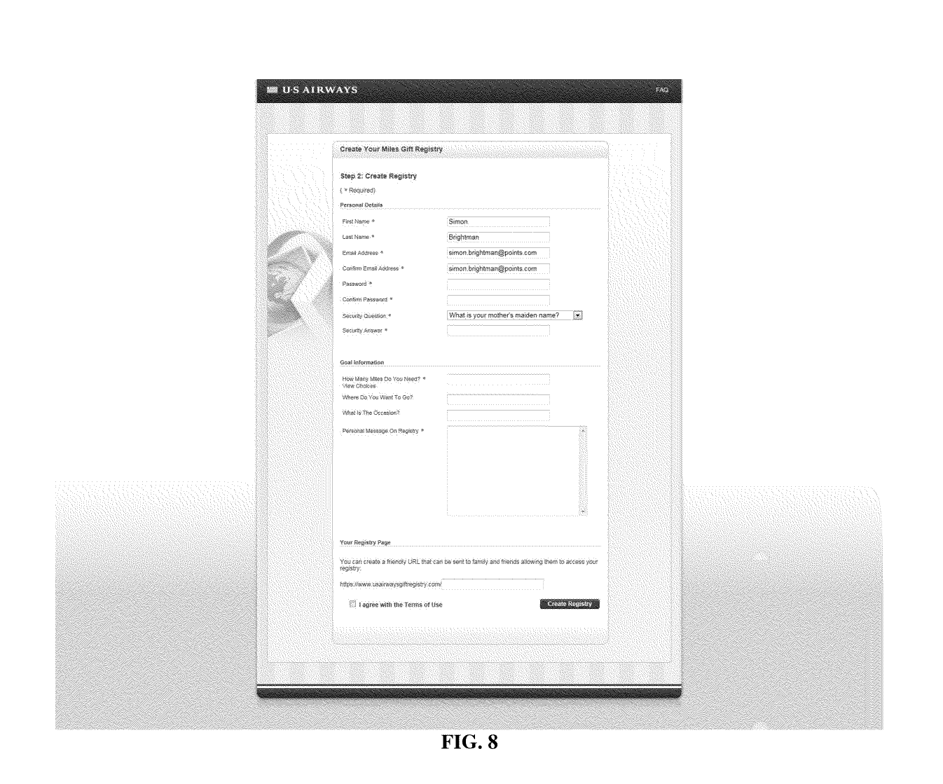

At block D4, the user is directed by the gift registry server to a gift registry configuration interface. An example of gift registry configuration interface is shown in FIG. 8.

The user establishes parameters for the gift registry. The parameters may comprise, for example, the number of loyalty points desired, a name of an event for which the registry is associated (e.g., a birthday, wedding, etc.) and for which the user desires to collect points, a personal message from the user, etc. Any of the parameters, such as the personal message for example, may be used by the gift registry server to provide a link, such as an URL, for potential contributors to access the gift registry via a web browser.

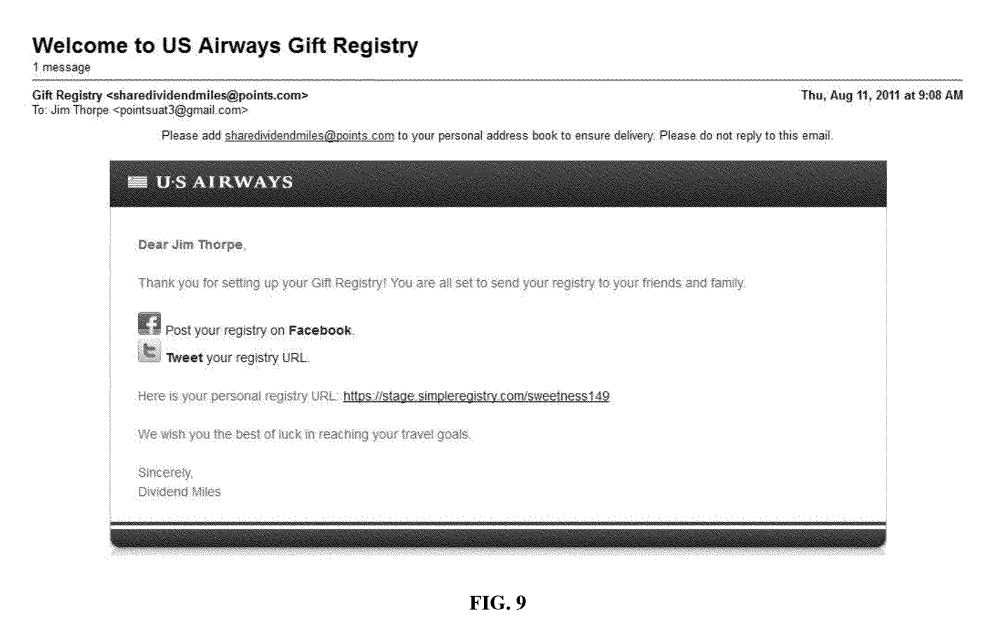

At block D5, the gift registry server establishes the user's gift registry and enables the user to login, or automatically logs the user in, to the gift registry using the ID and credentials previously generated by the gift registry server. At this time, the gift registry server may save the configured gift registry to the gift registry database. A setup confirmation interface may be presented to the user or emailed, by the email server, to the user. An example of a setup confirmation interface is shown in FIG. 9. The confirmation interface may comprise a link to the gift registry.

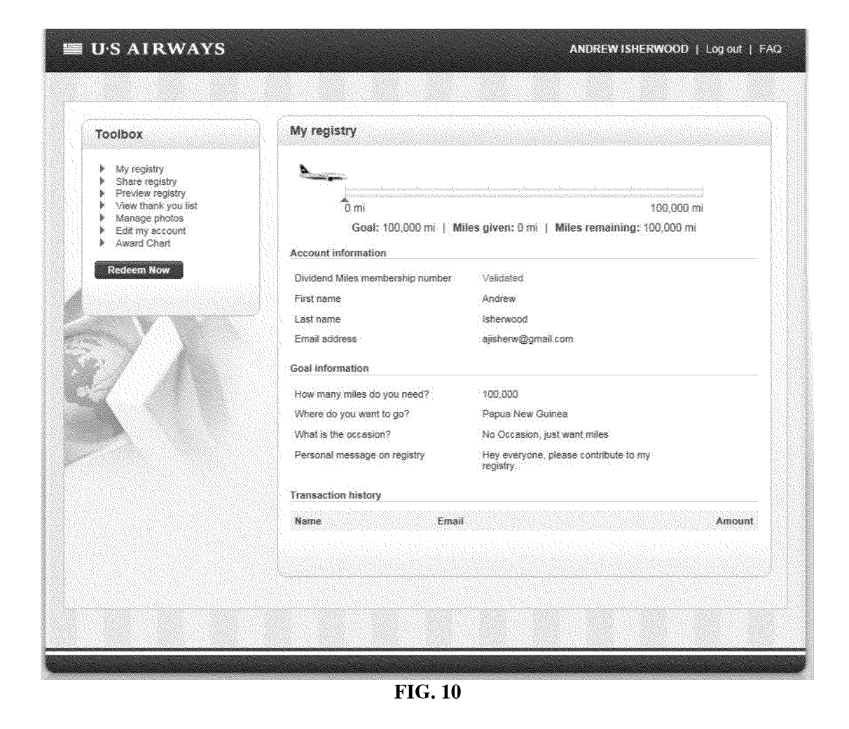

At block D6, the user is logged in to the gift registry and is presented with an administrator portal for the gift registry. The user may be directed from the login/register interface directly to the administrator portal if they are subsequently logging in, for example at block D1, rather than registering a gift registry. The administrator portal may comprise one or more interfaces that enable the user to access and configure the gift registry. An example of an interface in the administrator portal is shown in FIG. 10.

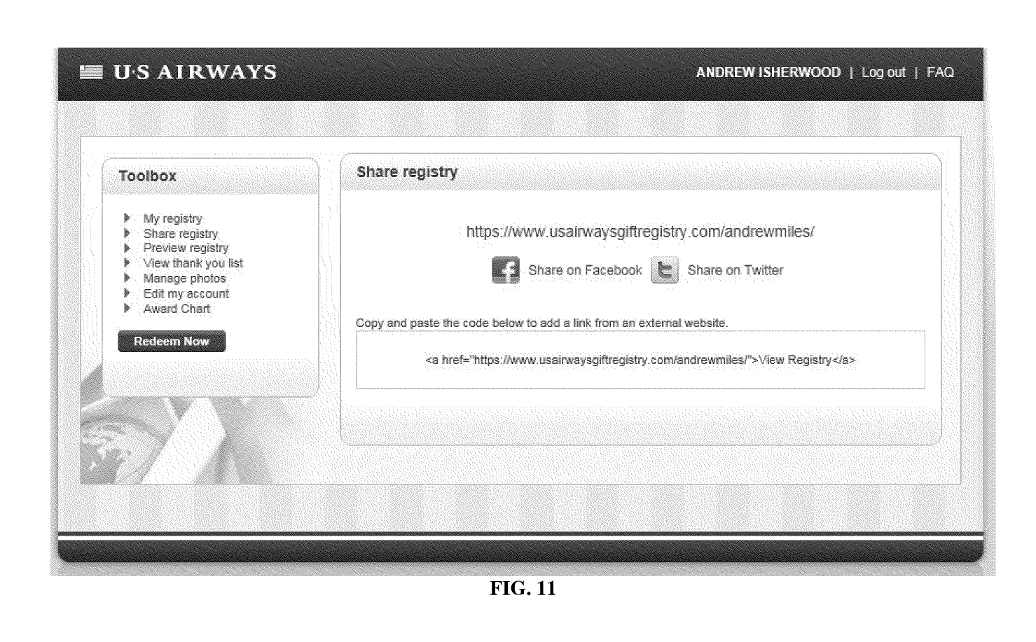

The administrator portal may include a sharing interface enabling the user to configure sharing options to publicize the gift registry. An example of a sharing interface is shown in FIG. 11. The sharing options may include, for example, sharing a link to the gift registry via a social network (e.g., Facebook™, Twitter™), email (via the email server), embedded HTML link, or other messaging medium. At block D7, the user can configure sharing options to share the link.

Once the user has selected to share the link, at block D8, the user selects one or more sharing options and may be prompted to enter the information they wish to share, along with the medium, after which the user can select a “share” command to share the link on the medium. Optionally, the user may be requested to provide login information for the medium (e.g., Facebook login credentials), or the client computer can provide the information to the gift registry server automatically, via a cookie, for example.

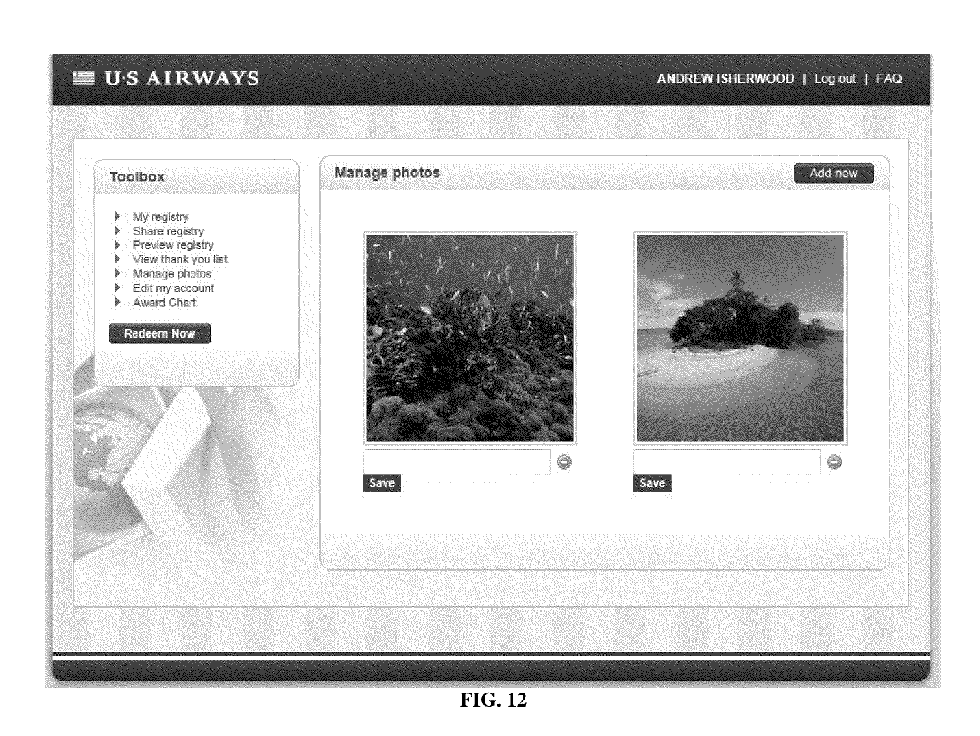

The administrator portal may include a content upload interface to enable the user to provide additional content to be viewed by potential contributors to the gift registry. An example of a content upload interface is shown in FIG. 12. In block D9, for example, the user may upload one or more images to their registry, or link to images located elsewhere in the cloud, add captions to the images, or delete images if desired. Other types of media may similarly be provided. At this time, the gift registry server may save the configured gift registry to the gift registry database.

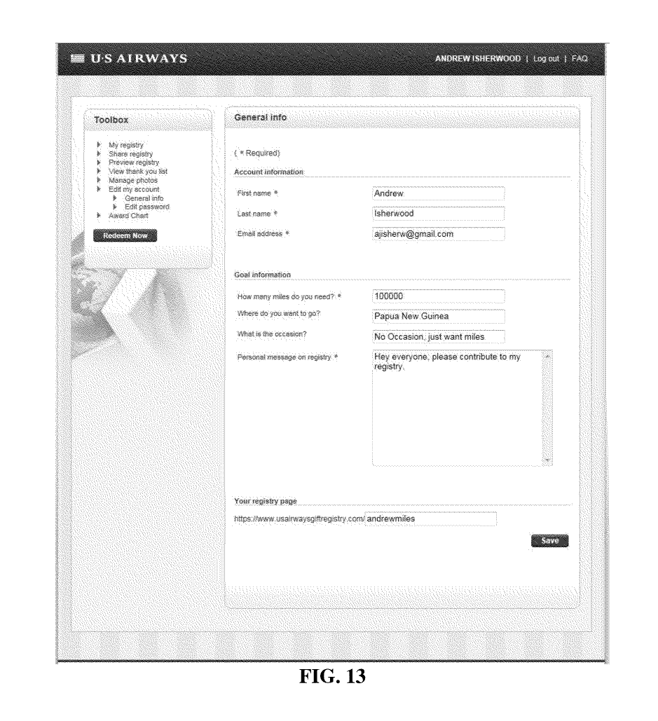

The administrator portal may also include a configuration interface to enable the user to edit gift registry account information. An example of a configuration interface is shown in FIG. 13. In block D10, for example, the user may edit account information or change any of the gift registry parameters. At this time, the gift registry server may save the configured gift registry to the gift registry database.

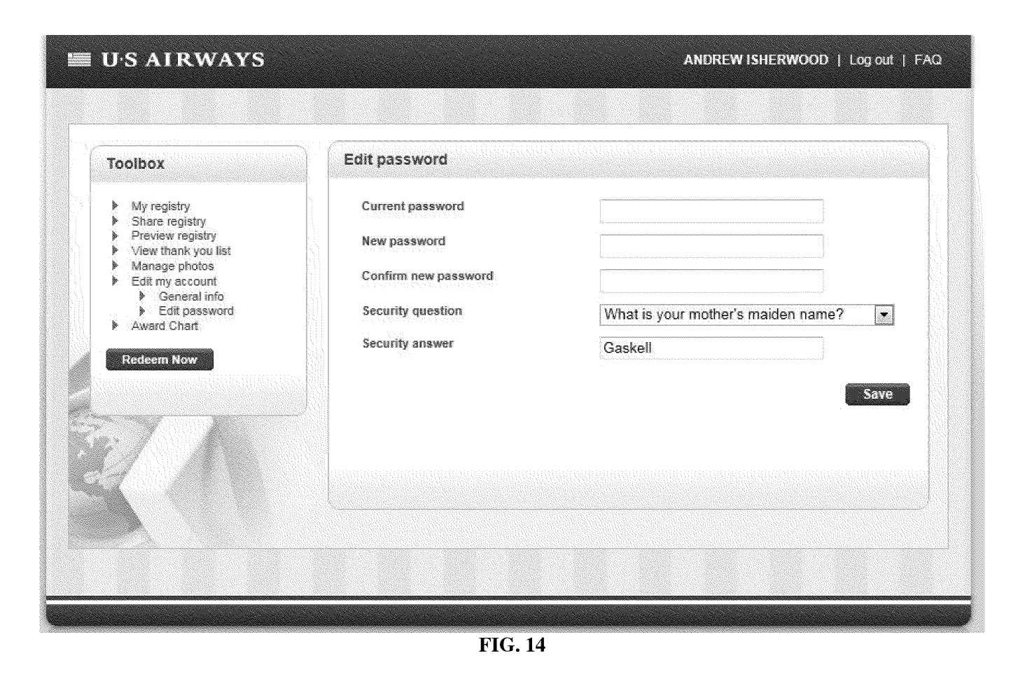

The administrator portal may also include a credential configuration interface to enable the user to edit credentials, or security questions/answers to recover forgotten credentials, as shown at block D11. An example of a credential configuration interface is shown in FIG. 14. At this time, the gift registry server may save the configured gift registry to the gift registry database.

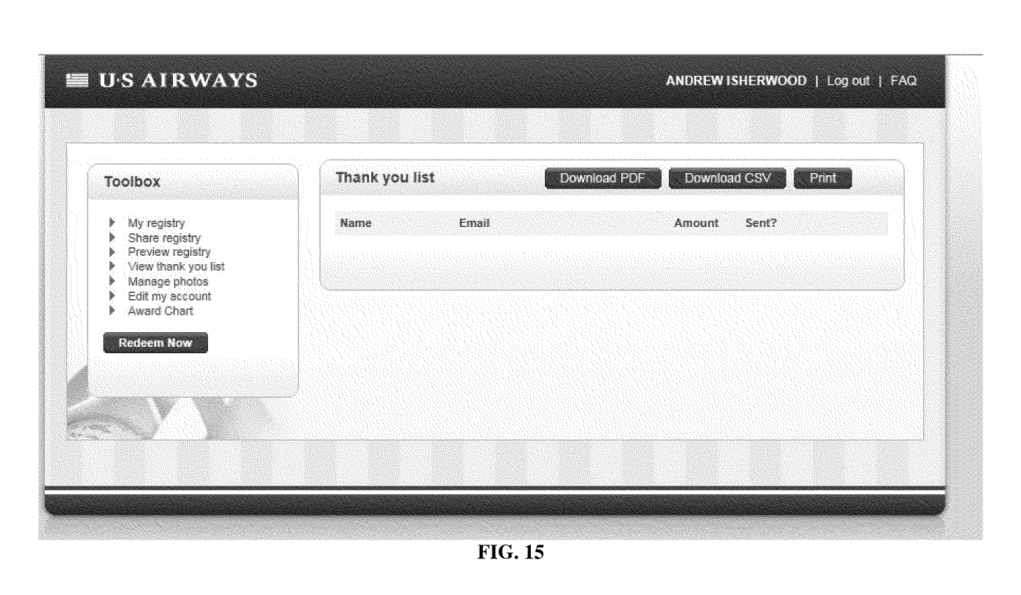

The administrator portal may also include a received gift interface to enable the user to view a list of gifts made by contributors to their gift registry. An example of a received gift interface is shown in FIG. 15. In block D12, the user views the list of gifts. The user may export the list of gifts, for example into a PDF document, a printable view or downloaded as a spreadsheet.

The administrator portal may also include a summary interface to enable the user to view a summary of the status of the gift registry. In block D13, the user views a gift registry summary that summarizes the gifts to their gift registry, total and remaining desired loyalty points, event name and registry message. The summary interface may be provided in the main interface, an example of which is shown in FIG. 10.

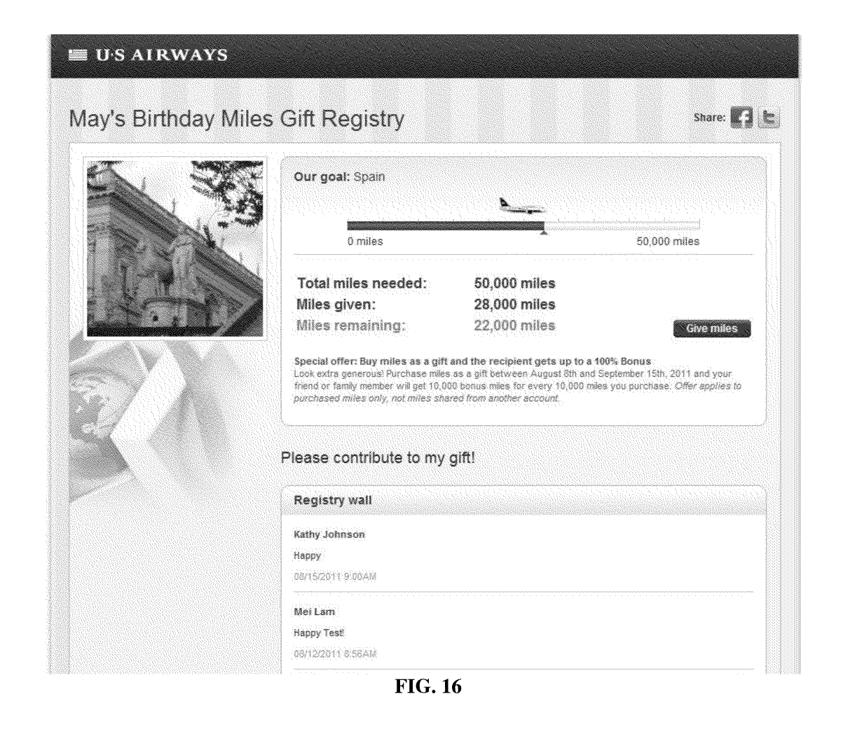

In blocks D14 and D15, the gift registry server enables the user to view a preview interface to preview the gift registry, i.e., view the gift registry as a potential contributor would. An example of a preview interface is shown in FIG. 16.

In another aspect, the gift registry server is accessible by one or more users from a network connected client computer to make contributions to a gift registry and thereby enable the users to be contributors.

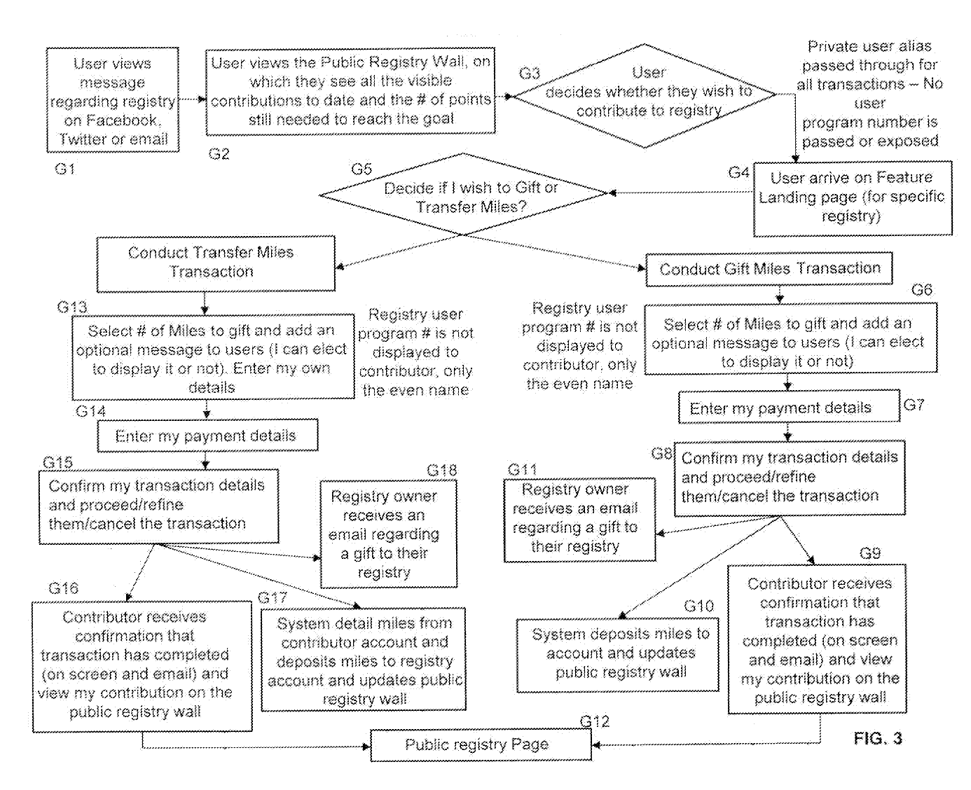

Referring now to FIG. 3, an example of a sequence of steps for enabling a contributor to contribute to a gift registry is shown. The contributor has received the link to the gift registry via a sharing medium. The link provided is to the gift registry and therefore does not expose the owner's loyalty account credentials or balance.

In block G1, the contributor may receive the link from a Facebook message or feed. The contributor views the message from the registry owner, with a message pertaining to the registry and the link to access it. The link may also be received from Twitter, email (via the email server), a web page, or other medium, as previously mentioned.

In block G2, the contributor accesses an interface for the public gift registry (the “public gift registry wall”), which may include progress towards the goal and a list of contributions that were designated to be displayed by previously contributors. The public gift registry wall may be similar to that previously shown in FIG. 16.

The gift registry server provides the contributor with only limited information associated with the gift registry, such as the name of the event for the registry, but preferably not the loyalty account information (e.g., account number, loyalty points accrued) with which it is associated. Thus, the contributor is preferably not able to determine how many loyalty points the owner has, but only the number of loyalty points the owner has obtained by the gift registry. Therefore, in the event the owner has a substantial number of loyalty points not by the gift registry, the contributor is still likely to gift loyalty points to the owner.

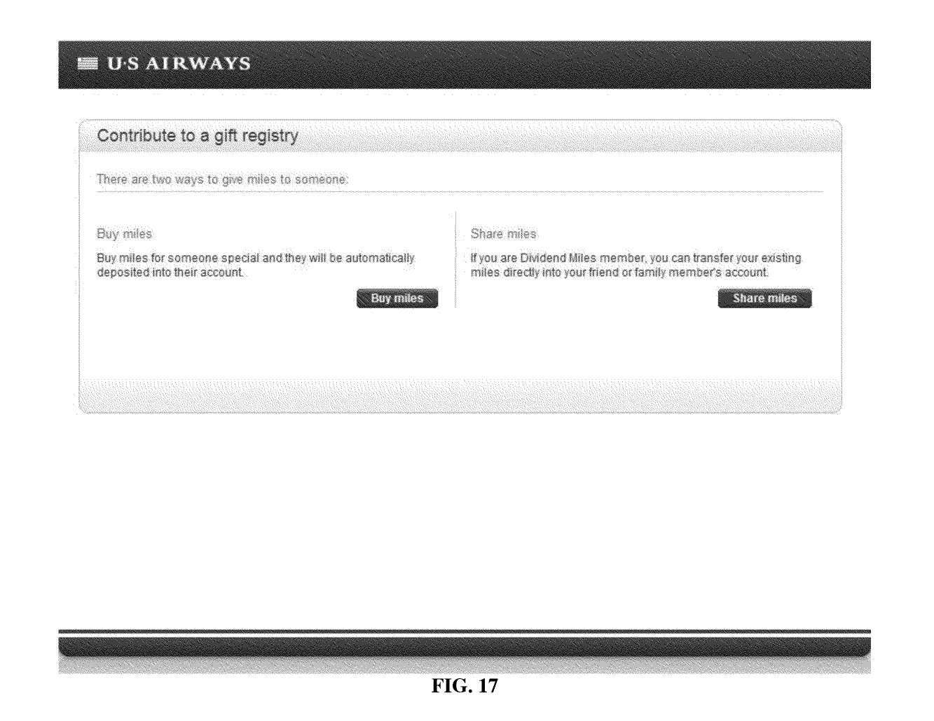

In block G3, the contributor selects on the public gift registry wall a “Give Miles/Points” command if they wish to contribute to the registry. In block G4, the contributor is provided with a feature landing interface, providing the contributor with the option to buy or share loyalty points. An example of a feature landing interface is shown in FIG. 17. In block G5, the user selects from the feature landing interface, either buy or share loyalty points.

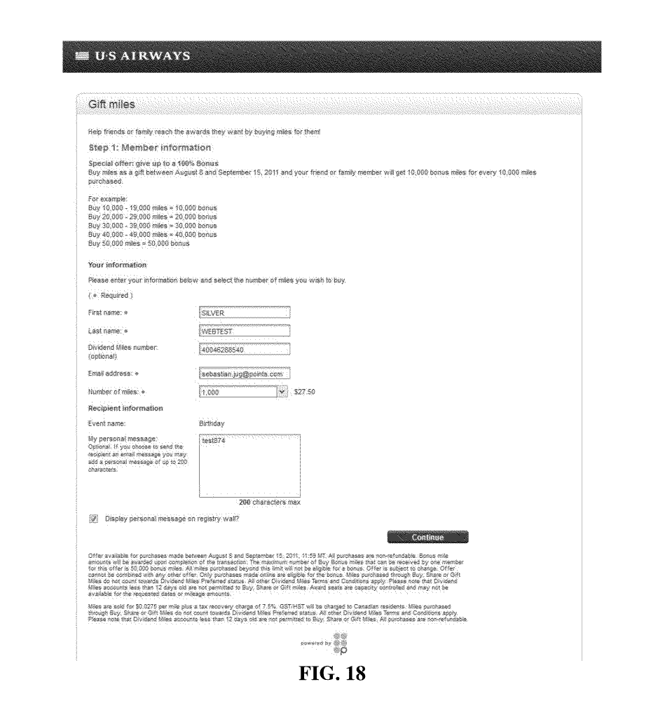

If the contributor selects to buy loyalty points for the owner, then in block G6 the gift registry server provides the contributor with a purchase contribution interface. An example of a purchase contribution interface is shown in FIG. 18. Again, the gift registry server provides the contributor with the name of the event for the registry, but preferably not the loyalty account information (e.g., account number, loyalty points accrued) with which it is associated.

On the purchase contribution interface, the contributor selects the number of loyalty points they wish to buy for the registry owner. The contributor may add an optional message that will be displayed to the registry owner upon receiving the gift, and elects whether or not the gift should be displayed on the public gift registry wall. The contributor selects to proceed to a payment interface to pay for the gift.

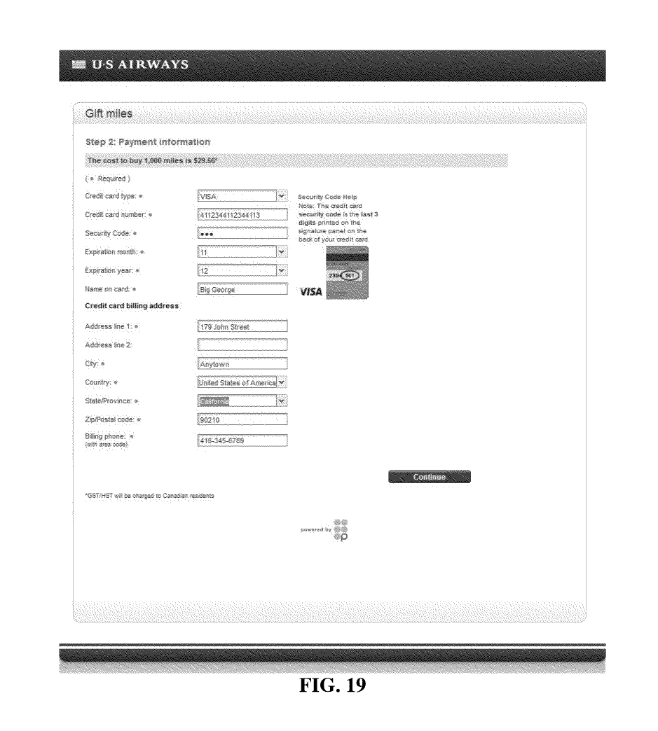

In block G7, the contributor is provided with a payment interface. An example of a payment interface is shown in FIG. 19. On the payment interface, the contributor may enter payment information, such as credit card information, credentials for a cloud-based payment provider, or credentials for a deposit account linked to the gift registry server. Upon the contributor selecting a proceed command, the gift registry server validates the payment details. If the details are incorrect, the gift is aborted or the contributor is requested to re-enter payment details.

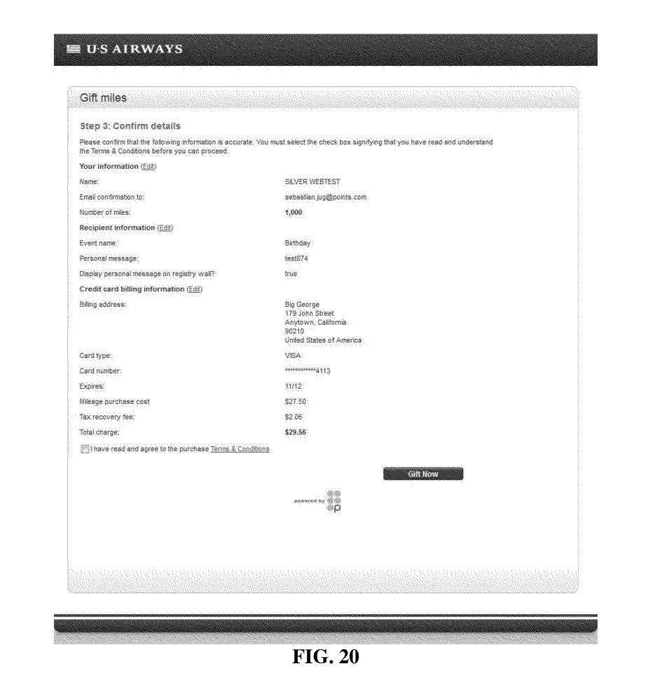

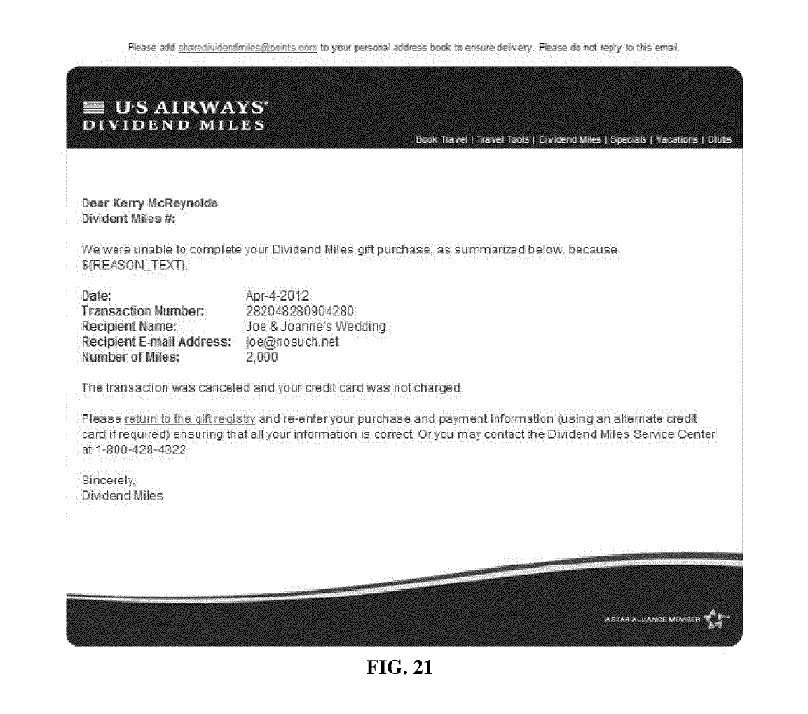

In block G8, once the payment details are validated, the contributor is provided with a payment confirmation interface from which they can proceed or edit any details so far entered. An example of a payment confirmation interface is shown in FIG. 20. Once the contributor has confirmed details, they may be requested to implicitly or explicitly accept terms and conditions for the gift registry system, and submit the gift. Once the gift is submitted, payment is obtained from the contributor, by directing the payment provider or payment clearing provider to obtain payment. If there is any error in processing the gift, the gift registry server provides the contributor with an error notification, which may be provided as a interface, by email, via the email server, or another messaging medium. An example of an emailed error notification is shown in FIG. 21.

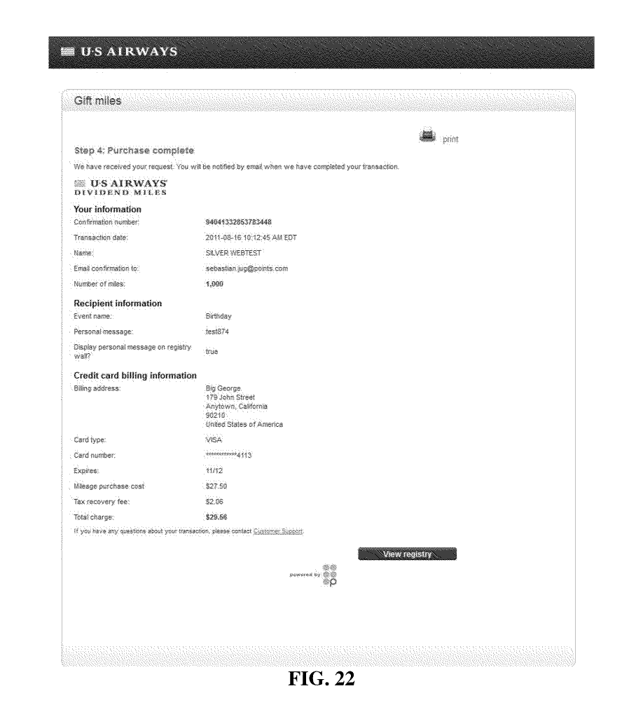

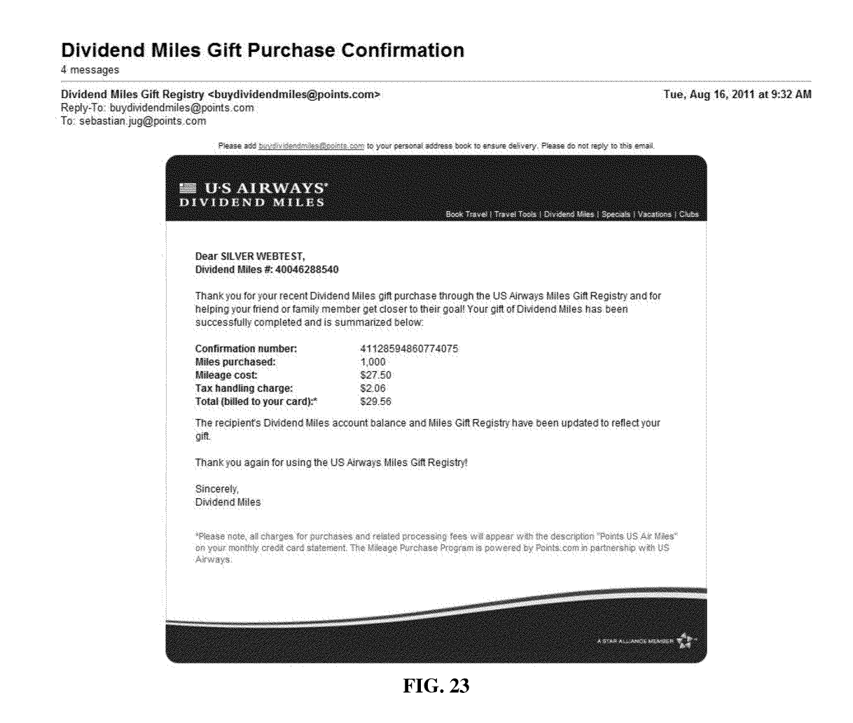

In block G9, the contributor may be provided with a receipt interface showing gift details and a gift number (transaction ID) that can be printed, saved or emailed, via the email server, as a receipt for the gift. The contributor may also be provided with an option to view the public gift registry wall. An example of a receipt interface is shown in FIG. 22. An example of an emailed receipt is shown in FIG. 23.

In block G10, the gift registry server posts the gifted loyalty points to the gift registry and updates the gift registry including its public gift registry wall. The loyalty points are added to the owner's loyalty account. At this time, the gift registry server may save the configured gift registry to the gift registry database.

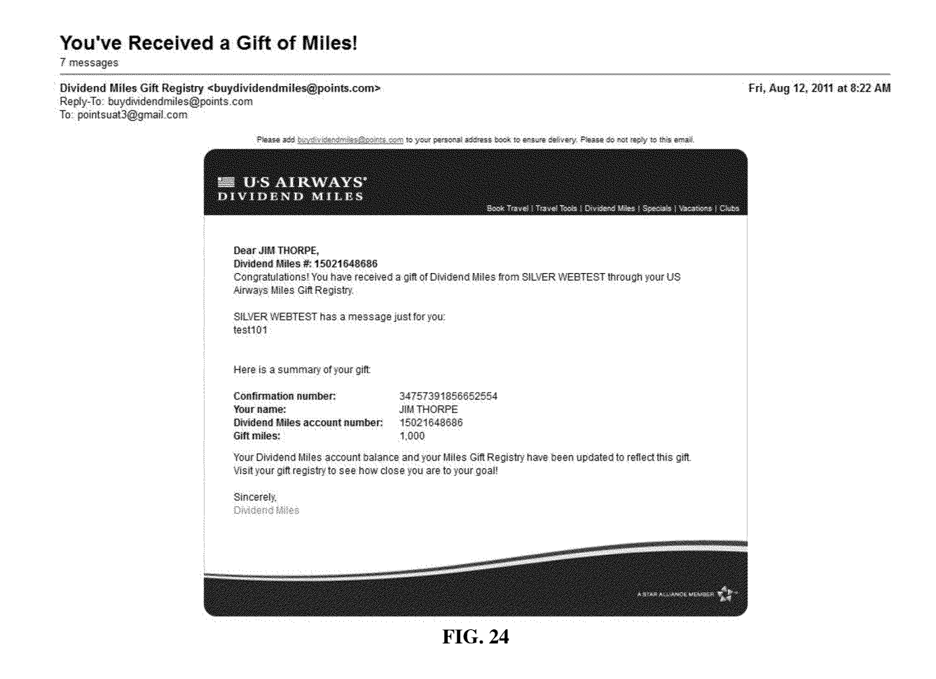

In block G11, the gift registry server notifies the registry owner by email, via the email server, or other messaging medium about the gift. An example of an emailed gift notification is shown in FIG. 24.

In block G12, the contributor selects to view the public gift registry wall and is taken to an interface displaying the current progress to towards the goal as well as their message assuming it was designated to be displayed. A delay of preconfigured time may be used if real-time updating is not desired.

In block G13, contributor may have alternatively selected to share loyalty points rather than purchase loyalty points. As in block G6, again, the gift registry server provides the contributor with the name of the event for the registry, but preferably not the loyalty account information (e.g., account number, loyalty points accrued) associated with it.

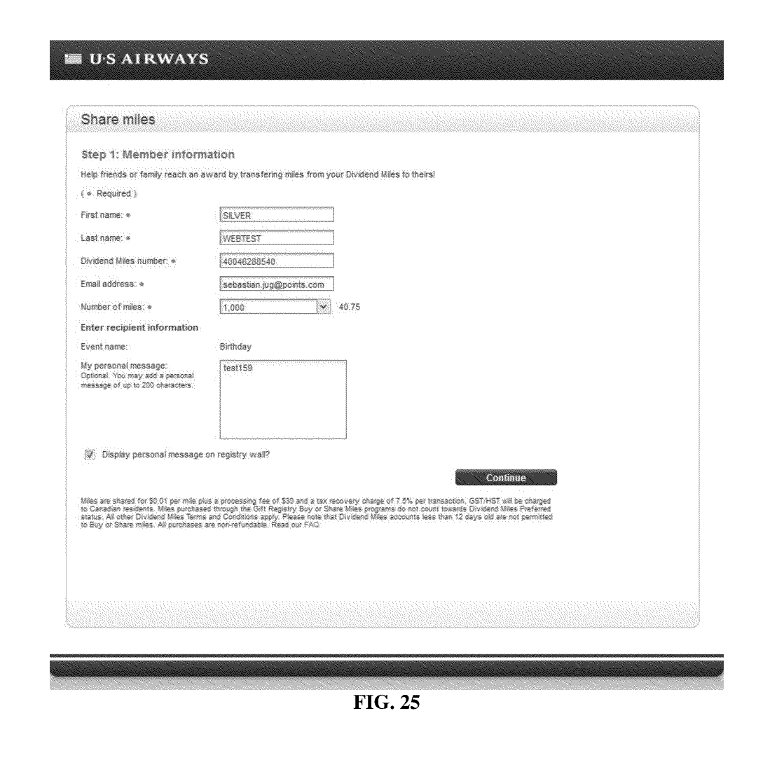

The gift registry server provides the contributor with a sharing contribution interface. An example of a sharing contribution interface is shown in FIG. 25. On the sharing contribution interface, the contributor selects the number of loyalty points they wish to gift to the registry owner. The contributor may add an optional message that will be displayed to the registry owner upon receiving the gift, and elects whether or not the gift should be displayed on the public gift registry wall. The contributor selects to proceed to a payment interface to pay for the gift.

The contributor provides on the sharing contribution interface their own loyalty account information, preferably including account number and credentials. The contributor selects the number of loyalty points they wish to gift to the owner. The contributor may add an optional message that will be displayed to the registry owner and elects whether or not to display it on the gift registry public wall. The contributor selects to proceed to a payment interface.

In block G14, the contributor may be provided with a payment interface for enabling the contributor to provide a payment in connection with the contribution. The payment may, for example, be a transaction fee charged by any one or more of an owner of the gift registry server, the loyalty providers, the payment providers or payment clearing providers. The payment may alternatively, or in addition, for example, be a top-up fee payment in the event the contributor does not have access to the number of loyalty points they wish to gift. In this case, the fee may include payment for the number of loyalty points that the contributor is deficient.

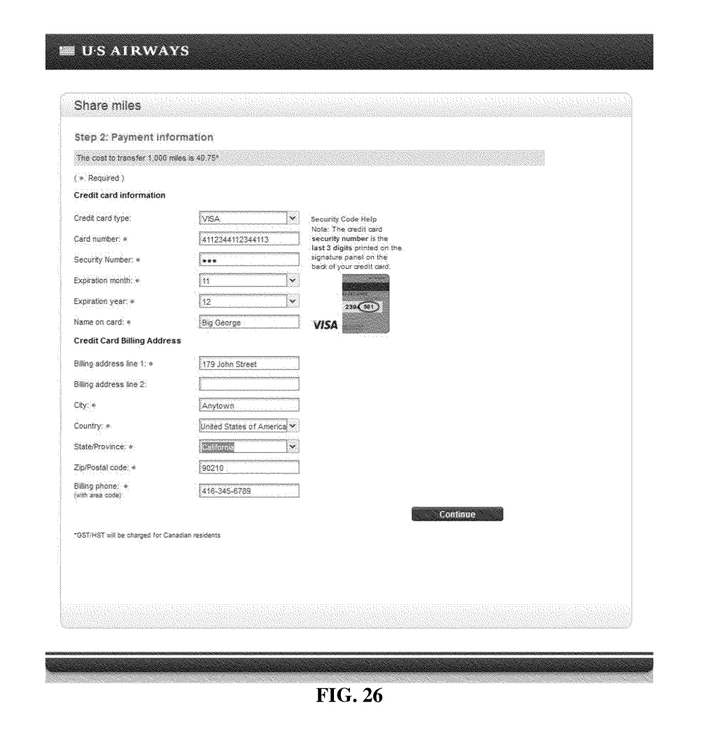

An example of a payment interface is shown in FIG. 26. The user provides on the payment interface, payment information and selects to proceed to a confirmation interface. The gift registry server validates the payment information as previously described.

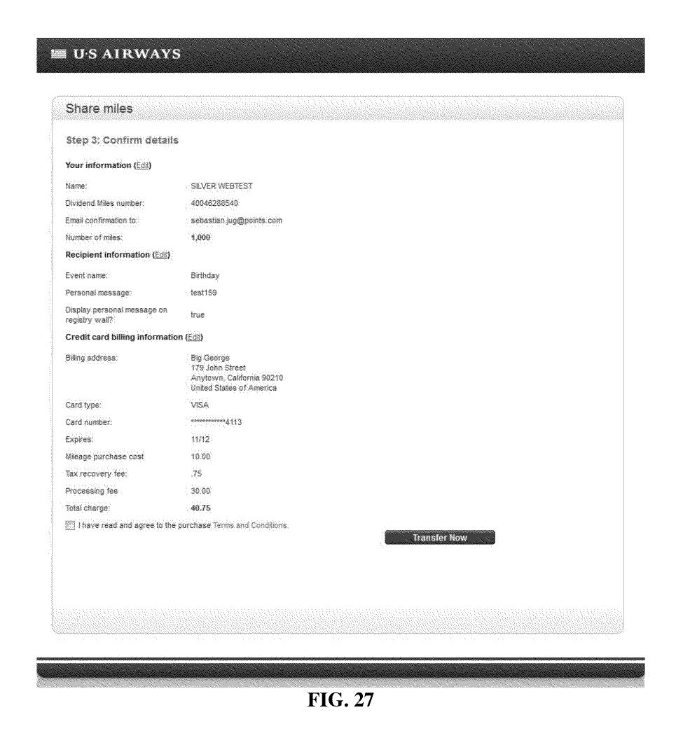

In block G15, the contributor is provided with a sharing confirmation interface, from which the contributor can proceed or edit any details entered thus far. An example of a sharing confirmation interface is shown in FIG. 27. The user may confirm details, accept terms and conditions and submit the transaction.

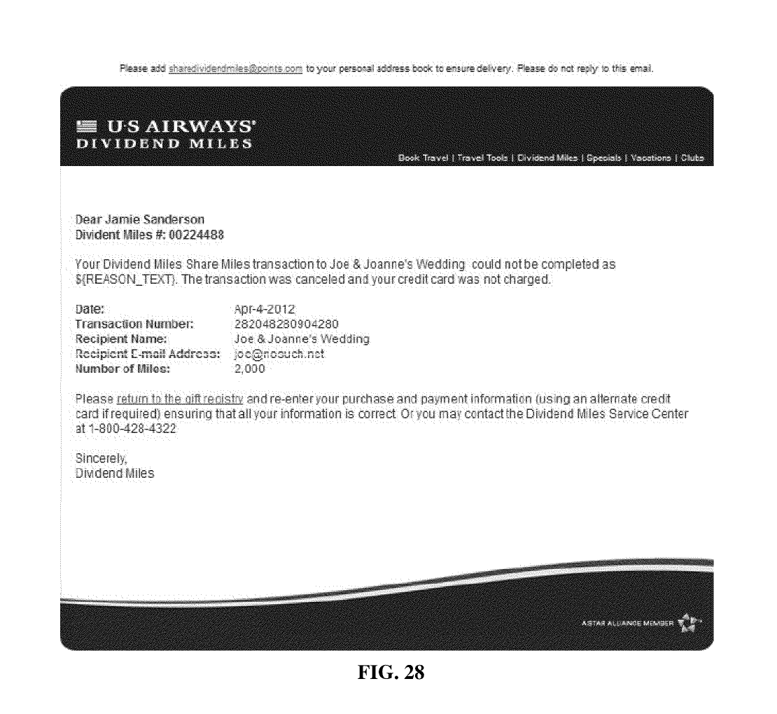

If there is any error in processing the gift, the gift registry server provides the contributor with an error notification, which may be provided as a interface, by email, via the email server, or another messaging medium. An example of an emailed error notification is shown in FIG. 28.

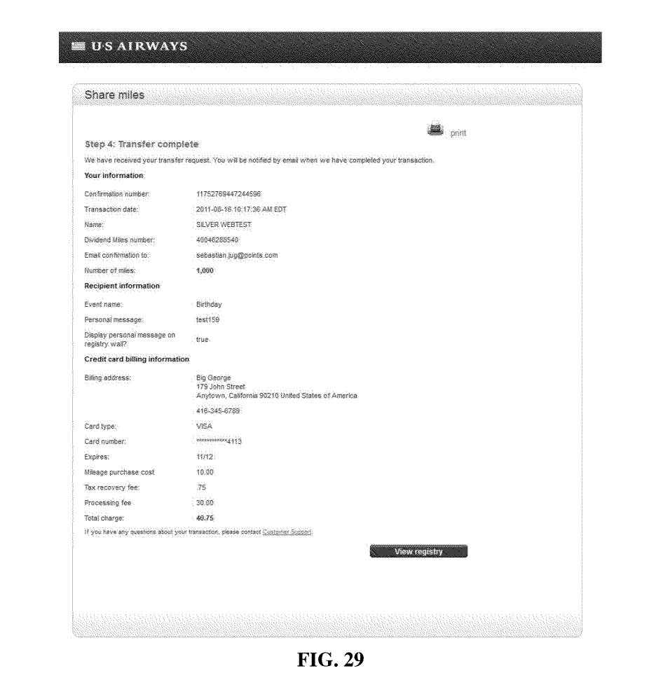

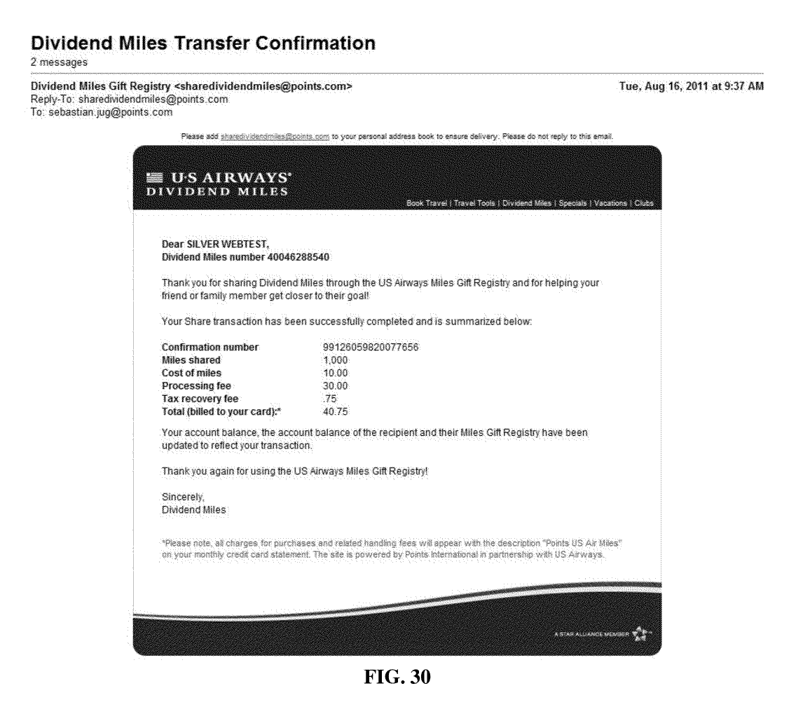

In block G16, as in block G9, the contributor may be provided with a receipt interface showing gift details and a gift number (transaction ID) that can be printed, saved or emailed, via the email server, as a receipt for the gift. The contributor may also be provided with an option to view the public gift registry wall. An example of a receipt interface is shown in FIG. 29. An example of a sharing receipt is shown in FIG. 30.

In block G17, the gift registry server posts the gifted loyalty points to the gift registry and directs the loyalty program to debit loyalty points from the contributor account and add the loyalty points to the owner's loyalty account. The gift registry server updates the gift registry including the public gift registry wall. At this time, the gift registry server may save the configured gift registry to the gift registry database.

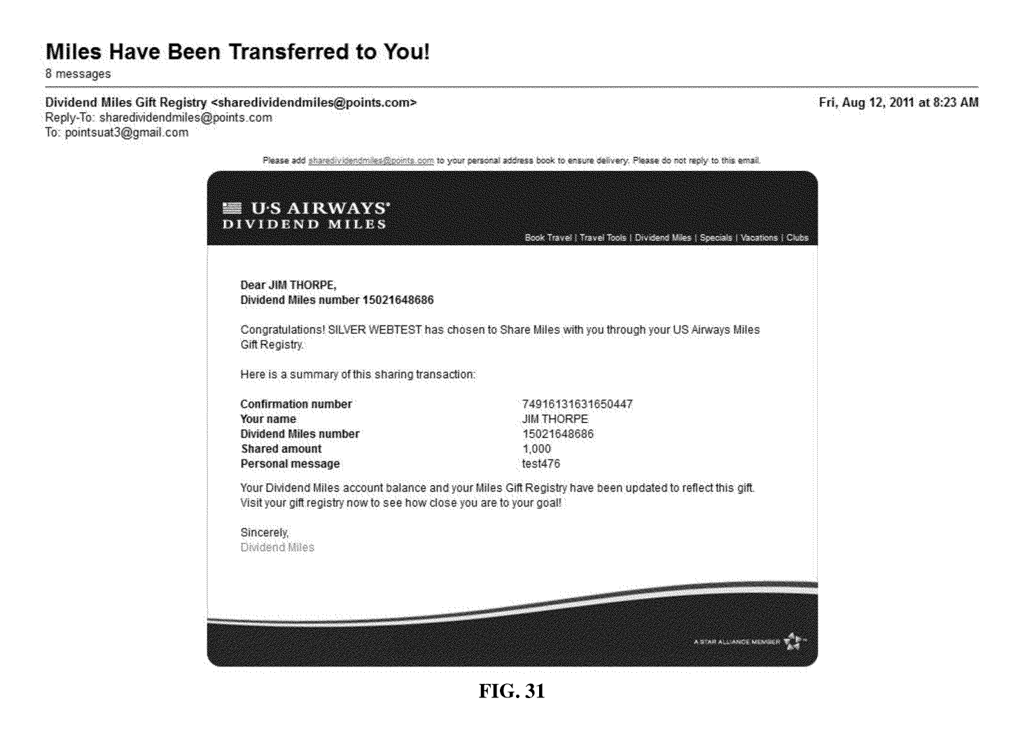

In block G18, the gift registry server notifies the registry owner by email, via the email server, or other messaging medium about the gift. An example of an emailed error notification is shown in FIG. 31.

In block G12, the contributor selects to view the public gift registry wall and is taken to an interface displaying the current progress to towards the goal as well as their message assuming it was designated to be displayed. A delay of preconfigured time may be used if real-time updating is not desired.

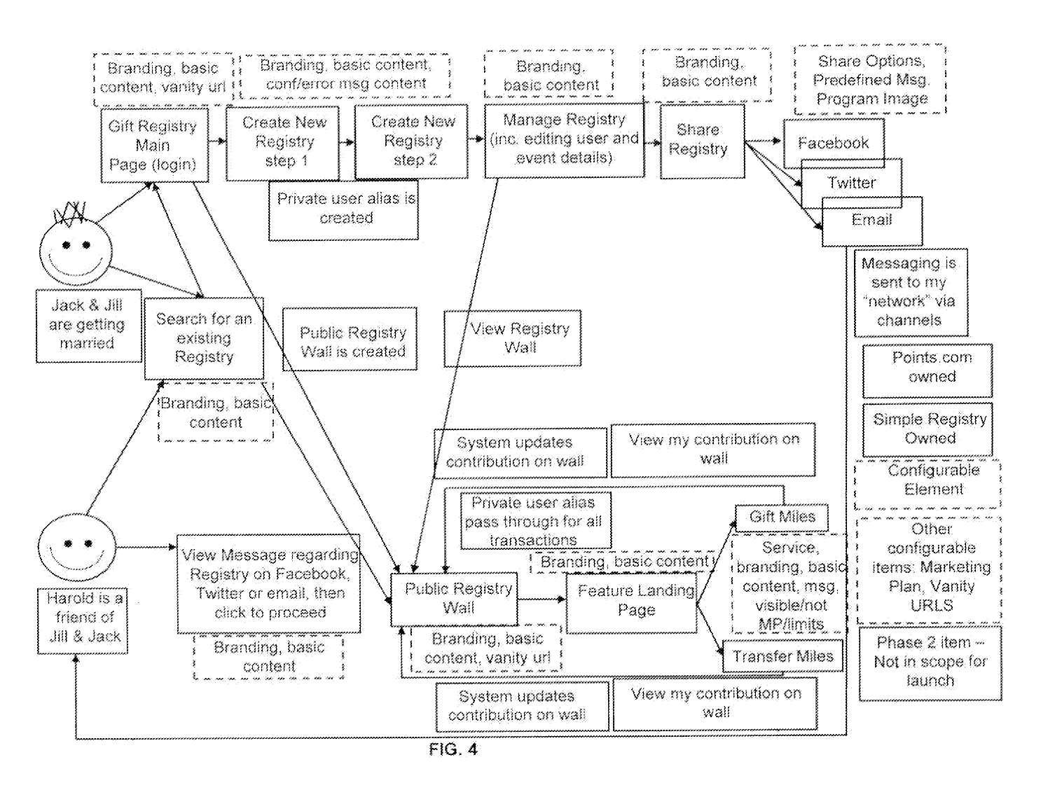

Referring now to FIG. 4, an example of the gift registry system in use is shown. In use, a user may create a gift registry and publicize the availability of the gift registry to one or more other users. The other users can access the gift registry and make contributions to the gift registry.

The gift registry owner accesses the gift registry system and can either login to the gift registry, establish a new gift registry, search for a gift registry of another owner, or access a public gift registry wall of any gift registry on the gift registry system.

If the owner selects to establish a new gift registry, the owner completes the gift registry configuration previously described. The owner can then manage/configure the gift registry at any time, or view its own or another owner's public gift registry wall. The owner may also share the gift registry link via a sharing medium, as previously described.

Upon sharing a gift registry link with a potential contributor, the potential contributor receives the link via the sharing medium. The potential contributor can access the link to be directed to the public gift registry wall for the owner. Alternatively, the potential contributor could search all gift registries to access the public gift registry wall for the gift registry it is seeking.

From the public gift registry wall, the potential contributor can purchase or share loyalty points, as previously described.

It should be understood that the gift registry system can be implemented as a third party system distinct from a loyalty system, or could be integrated therein. Correspondingly, the gift registry system may include branding, advertising, etc. of third parties and/or of the loyalty provider.

Although the invention has been described with reference to certain specific embodiments, various modifications thereof will be apparent to those skilled in the art without departing from the scope of the invention as outlined in the claims appended hereto. The entire disclosures of all references recited above are incorporated herein by reference.

What is claimed is:

1. A method of establishing a loyalty point gift registry comprising:
(a) obtaining loyalty point account information for a loyalty point account capable of accumulating loyalty points;
(b) linking the loyalty point account information to the loyalty point gift registry;
(c) generating, by one or more processors, a publicly accessible profile for the loyalty point gift registry that retains at least the loyalty points as private; and
(d) enabling a contributor to contribute at least one loyalty point to the loyalty point account using the publicly accessible profile.

2. The method of claim 1, wherein the contribution is made by purchasing the at least one loyalty point.

3. The method of claim 1, wherein the contribution is made by transferring the at least one loyalty point from another loyalty point account associated with the contributor.

4. The method of claim 1, wherein the contribution is made by transferring the at least one loyalty point from another loyalty point account associated with the contributor and purchasing at least one additional loyalty point.

5. The method of claim 1, further comprising enabling an owner of the loyalty point account to establish a goal for the number of loyalty points to be accrued to the loyalty point account by the loyalty point gift registry.

6. The method of claim 5, wherein the publicly accessible profile displays to a contributor the goal and the loyalty points accrued by the loyalty point gift registry.

7. The method of claim 1, further comprising enabling an owner of the loyalty point account to disseminate a link to potential contributors to access the loyalty point gift registry.

8. The method of claim 7, wherein the link is disseminated via a social network.

9. The method of claim 1, wherein the loyalty point gift registry is assigned an identifier that prevents potential contributors from determining identifying loyalty account information of the owner.

10. The method of claim 1, further comprising generating a privately accessible profile page for the loyalty point gift registry that does not retain the loyalty points as private.

11. A system for establishing a loyalty point gift registry comprising a gift registry server operable to:
(a) obtain loyalty point account information for a loyalty point account capable of accumulating loyalty points;
(b) link the loyalty point account information to the loyalty point gift registry;
(c) generate a publicly accessible profile for the loyalty point gift registry that retains at least the loyalty points as private; and
(d) enable a contributor to contribute at least one loyalty point to the loyalty point account using the publicly accessible profile.

12. The system of claim 11, wherein the gift registry server enables the contributor to contribute the at least one loyalty point by purchasing the at least one loyalty point.

13. The system of claim 11, wherein the gift registry server enables the contributor to contribute the at least one loyalty point by transferring the at least one loyalty point from another loyalty point account associated with the contributor.

14. The system of claim 11, wherein the gift registry server enables the contributor to contribute the at least one loyalty point by transferring the at least one loyalty point from another loyalty point account associated with the contributor and purchasing at least one additional loyalty point.

15. The system of claim 11, wherein the gift registry server an owner of the loyalty point account to establish a goal for the number of loyalty points to be accrued to the loyalty point account by the loyalty point gift registry.

16. The system of claim 15, wherein the publicly accessible profile displays to a contributor the goal and the loyalty points accrued by the loyalty point gift registry.

17. The system of claim 11, wherein the gift registry server enables an owner of the loyalty point account to disseminate a link to potential contributors to access the loyalty point gift registry.

18. The system of claim 17, wherein the link is disseminated via a social network.

19. The system of claim 11, wherein the gift registry server assigns the loyalty point gift registry an identifier that prevents potential contributors from determining identifying loyalty account information of the owner.

20. The system of claim 11, wherein the loyalty point gift registry generates a privately accessible profile page for the loyalty point gift registry that does not retain the loyalty points as private.
